(19) United States
(12) Patent Application Publication
(10) Pub. No.: US 2023/0334371 A1
(43) Pub. Date: Oct. 19, 2023

(54) METHOD FOR TRAINING A MACHINE LEARNING ALGORITHM TAKING INTO ACCOUNT AT LEAST ONE INEQUALITY CONSTRAINT

(71) Applicant: Robert Bosch GmbH, Stuttgart (DE)

(72) Inventors: Frank Hutter, Freiburg Im Breisgau (DE); Suhei Watanabe, Freiburg (DE)

(21) Appl. No.: 18/299,213

(22) Filed: Apr. 12, 2023

(30) Foreign Application Priority Data
Apr. 19, 2022 (DE) 10 2022 203 834.7

(51) Int. Cl. G06N 20/00

(52) U.S. Cl. CPC G06N 20/00

(57) ABSTRACT

A method for training a machine learning algorithm taking into account at least one inequality constraint. Each of the at least one inequality constraint represents a secondary constraint. The method includes: optimizing hyperparameters for the machine learning algorithm by applying a tree-structured Parzen estimator, wherein the tree-structured Parzen estimator is based on an acquisition function adapted on the basis of the at least one inequality constraint; and training the machine learning algorithm on the basis of the optimized hyperparameters.

### CROSS REFERENCE

The present application claims the benefit under 35 U.S.C. § 119 of German Patent Application No. DE 10 2022 203 834.7 filed on Apr. 19, 2022, which is expressly incorporated herein by reference in its entirety.

### FIELD

The present invention relates to a method for training a machine learning algorithm taking into account at least one inequality constraint, wherein each of the at least one inequality constraints represents a secondary constraint, and in particular relates to a method for training a machine learning algorithm on the basis of hyperparameters, wherein the hyperparameters have been optimized taking into account at least one inequality constraint.

### BACKGROUND INFORMATION

The general basis of machine learning algorithms is that statistical methods are used to train a data processing system such that it can execute a particular task without having originally been explicitly programmed to do so. The aim of machine learning is to construct algorithms that can learn from data and make predictions.

Before using or applying machine learning algorithms of this kind, these algorithms are trained on the basis of the training data characterizing the application in question, wherein weightings within the machine learning algorithm are automatically adapted such that the machine learning algorithm is increasingly able to reflect relationships between features and predictions or input data and corresponding output data.

However, training the machine learning algorithm does not influence the structure, for example the architecture of the machine learning algorithm, which is defined by so-called hyperparameters. Hyperparameters are the parameters of a machine learning algorithm that are not directly adapted by the training data or that need to be set before the training, for example the number of layers of a neural network.

Since, however, the quality or performance of a machine learning algorithm is also determined by its hyperparameters, it is important to optimize them before the machine learning algorithm is actually trained.

When optimizing hyperparameters, it is also important to take into account boundary conditions or secondary constraints, for example specifications relating to available computing resources. In this case, secondary constraints of this kind are often in the form of inequality constraints.

U.S. Pat. No. 11,093,833 B1 describes a method for training a machine learning algorithm, wherein the machine learning algorithm is trained on the basis of coordinated hyperparameter values. In this case, when a selected hyperparameter configuration does not fulfill a linear constraint, it is determined whether a projection of the selected hyperparameter configuration is contained in a first cache which stores previously calculated projections. If the projection is contained in the first cache, the projection is extracted from the first cache using the selected hyperparameter configuration and the selected hyperparameter configuration is replaced with the extracted projection. If the projection is not contained in the first cache, a calculated projection for the selected hyperparameter configuration is allocated to a session. A calculated projection is received by the session for the selected hyperparameter configuration. The calculated projection and the selected hyperparameter configuration are stored in the first cache and the selected hyperparameter configuration is replaced with the calculated projection.

An object of the present invention is to provide an improved method for training a machine learning algorithm taking into account secondary constraints in the form of inequality constraints.

The object may be achieved by a method for training a machine learning algorithm taking into account at least one inequality constraint according to the features of the present invention.

The object may also achieved by a controller for training a machine learning algorithm taking into account at least one inequality constraint according to the features of present invention.

### SUMMARY

According to one specific embodiment of the present invention, this object is achieved by a method for training a machine learning algorithm taking into account at least one inequality constraint, wherein each of the at least one inequality constraint represents a secondary constraint, and wherein the method comprises optimizing hyperparameters for the machine learning algorithm by applying a tree-structured Parzen estimator, wherein the tree-structured Parzen estimator is based on an acquisition function adapted on the basis of the at least one inequality constraint, and comprises training the machine learning algorithm on the basis of the optimized hyperparameters.

In this case, a tree-structured Parzen estimator is understood to be a method which handles categorical hyperparameters in a tree-structured manner, or a method which generates Parzen estimators in a search space comprising conditional hyperparameters. For example, the selection of the number of layers of a neural network and the selection of the number of neurons in the individual layers require a tree structure. In addition, two distributions are defined for the hyperparameters or densities, in particular one in which output values of an objective function are less than a threshold value and one in which the output values of the objective function are greater than or equal to the threshold value.

For example, in this case, the hyperparameters are divided into good values and bad values. In this case, in addition, the objective function is a function which converts hyperparameters into an actual value, and this actual value is to be minimized as part of the hyperparameter optimization. The two densities are then modeled using Parzen estimators or kernel density estimators, which constitute a simple average of kernels that are centered on available data points. In this case, a set of hyperparameters is output according to the greatest expected improvement, or the improvement potential of individual selections of hyperparameters is estimated.

In this case, in comparison with other common methods for optimizing hyperparameters, for example an evolution strategy, tree-structured Parzen estimators are characterized by their versatility and stable performance, especially since these are based on distributions.

In this case, an acquisition function or selection function also indicates a function which defines the criterion in accordance with which the next set of hyperparameters is selected. This criterion may be an expected improvement, for example.

An advantage of the acquisition function being adapted on the basis of the at least one inequality constraint is that the hyperparameters can be optimized effectively even when there is at least one inequality constraint, for example specifications relating to the computing resources available for optimizing the hyperparameters or training the machine learning algorithm, and the optimized hyperparameters are robust in relation to the at least one inequality constraint.

Overall, an improved method for training a machine learning algorithm taking into account secondary constraints in the form of inequality constraints is thus provided.

In one specific embodiment of the present invention, the method further comprises a step of ascertaining the acquisition function adapted on the basis of the at least one inequality constraint, wherein ascertaining the acquisition function adapted on the basis of the at least one inequality constraint includes factorizing each of the at least one inequality constraint.

In this case, ‘factorizing’ is understood to mean breaking an object down into a plurality of non-trivial factors. In particular, in this case, the inequality constraints or a mathematical definition of the secondary constraints can in turn be broken down into two distributions, which can then be further processed by the tree-structured Parzen estimators and in particular the corresponding acquisition function, in particular one in which output values of the corresponding objective function are less than a threshold value and one in which the output values of the objective function are greater than or equal to the threshold value.

Therefore, overall, a common, combined distribution for the model and the at least one inequality constraint or secondary constraint can be selected as a basis for the optimization of the hyperparameters, such that it can be ensured that the optimized hyperparameters are then also robust in relation to the at least one inequality constraint. In this case, the advantage of only distributions in respect of the at least one inequality constraint being taken into consideration is also that comparatively few computing resources are required overall for optimizing the hyperparameters. By way of the factorization or the different distributions relating to the at least one inequality constraint, various observations relating to each of the at least one inequality constraint can also feed into the optimization of the hyperparameters.

In this case, ascertaining the acquisition function adapted on the basis of the at least one inequality constraint can further include multiplying an acquisition function for an objective function by an acquisition function for each of the at least one inequality constraints in each case. Therefore, the common, combined distribution for the model and the at least one inequality constraint can be ascertained in a simple manner and using comparatively few computing resources.

The at least one inequality constraint can further be at least one specification relating to available computing resources.

Therefore, conditions of the data processing system on which the optimization of the hyperparameters is performed or carried out can themselves feed into the optimization of the hyperparameters.

In a further specific embodiment of the present invention, a method for classifying image data is also provided, wherein image data are classified using a machine learning algorithm trained to classify image data, and wherein the machine learning algorithm has been trained using an above-described method for training a machine learning algorithm taking into account at least one inequality constraint.

Therefore, a method for classifying image data is provided which is based on a machine learning algorithm trained by an improved method for training a machine learning algorithm taking into account secondary constraints in the form of inequality constraints. In this case, the advantage of the optimization of the hyperparameters being based on an acquisition function adapted on the basis of the at least one inequality constraint is that the hyperparameters can be optimized effectively even when there is at least one inequality constraint, for example specifications relating to the computing resources available for optimizing the hyperparameters or training the machine learning algorithm, and the optimized hyperparameters are robust in relation to the at least one inequality constraint.

In particular, in this case, the corresponding machine learning algorithm can be used to classify image data, in particular digital image data, on the basis of low-level features, for example edges or pixel attributes. In the process, an image processing algorithm can additionally be used in order to analyze a classification feature that focuses on corresponding low-level features.

In a further specific embodiment of the present invention, a controller for training a machine learning algorithm taking into account at least one inequality constraint is also disclosed, wherein each of the at least one inequality constraint represents a secondary constraint, and wherein the controller comprises an optimization unit configured to optimize hyperparameters for the machine learning algorithm by applying a tree-structured Parzen estimator, wherein the tree-structured Parzen estimator is based on an acquisition function adapted on the basis of the at least one inequality constraint, and comprises a training unit configured to train the machine learning algorithm on the basis of the optimized hyperparameters.

Therefore, an improved controller for training a machine learning algorithm taking into account secondary constraints in the form of inequality constraints is provided. In this case, the controller is configured to optimize the hyperparameters on the basis of an acquisition function that has been adapted on the basis of the at least one inequality constraint, and this has the advantage that the hyperparameters can be optimized effectively even when there is at least one inequality constraint, for example specifications relating to the computing resources available for optimizing the hyperparameters or training the machine learning algorithm, and the optimized hyperparameters are robust in relation to the at least one inequality constraint.

In one specific embodiment of the present invention, the controller further comprises an ascertaining unit configured to ascertain the acquisition function adapted on the basis of the at least one inequality constraint, wherein ascertaining the acquisition function adapted on the basis of the at least one inequality constraint includes factorizing each of the at least one inequality constraint. Therefore, overall, a common, combined distribution for the model and the at least one inequality constraint or secondary constraint can be selected as a basis for the optimization of the hyperparameters, such that it can be ensured that the optimized hyperparameters are then also robust in relation to the at least one inequality constraint. In this case, the advantage of only distributions in respect of the at least one inequality constraint being taken into consideration is also that comparatively few computing resources are required overall for optimizing the hyperparameters. By way of the factorization or the different distributions relating to the at least one inequality constraint, various observations relating to each of the at least one inequality constraint can also feed into the optimization of the hyperparameters.

In this case, the ascertaining unit can be further configured to ascertain the acquisition function adapted on the basis of the at least one inequality constraint by multiplying an acquisition function for an objective function by an acquisition function for each of the at least one inequality constraint in each case. Therefore, the common, combined distribution for the model and the at least one inequality constraint can be ascertained in a simple manner and using comparatively few computing resources.

The at least one inequality constraint can again also be at least one specification relating to available computing resources. Therefore, conditions of the data processing system on which the optimization of the hyperparameters is performed or carried out can themselves feed into the optimization of the hyperparameters.

In a further specific embodiment of the present invention, a controller for classifying image data is also disclosed, wherein the controller is configured to classify image data using a machine learning algorithm trained to classify image data, and wherein the machine learning algorithm has been trained by an above-described controller for training a machine learning algorithm taking into account at least one inequality constraint.

Therefore, a controller for classifying image data is provided which is based on a machine learning algorithm trained by an improved controller for training a machine learning algorithm taking into account secondary constraints in the form of inequality constraints. In this case, the advantage of the optimization of the hyperparameters being based on an acquisition function adapted on the basis of specifications for the at least one inequality constraint is that the hyperparameters can be optimized effectively even when there is at least one inequality constraint, for example specifications relating to the computing resources available for optimizing the hyperparameters or training the machine learning algorithm, and the optimized hyperparameters are robust in relation to the at least one inequality constraint.

In particular, in this case, the corresponding machine learning algorithm can be used to classify image data, in particular digital image data, on the basis of low-level features, for example edges or pixel attributes. In the process, an image processing algorithm can additionally be used in order to analyze a classification feature that focuses on corresponding low-level features.

In summary, the present invention provides a method for training a machine learning algorithm on the basis of hyperparameters, wherein the hyperparameters have been optimized taking into account at least one inequality constraint.

The above-described embodiments and developments of the present invention can be combined in any manner.

Further possible embodiments, developments, and implementations of the present invention also include combinations of features of the present invention described above or below in relation to the exemplary embodiments, even if said combinations are not explicitly mentioned.

The figures are intended to give a broader understanding of the specific embodiments of the present invention. They illustrate specific embodiments and, together with the description, are aimed at explaining principles and concepts of the present invention.

Other specific embodiments of the present invention and many of the aforementioned advantages will become clear in relation to the figures. The elements shown in the drawings are not necessarily to scale.

### BRIEF DESCRIPTION OF THE DRAWINGS

FIG. 1 is a flow chart of a method for training a machine learning algorithm taking into account at least one inequality constraint according to specific embodiments of the present invention.

FIG. 2 is a schematic block diagram of a controller for training a machine learning algorithm taking into account at least one inequality constraint according to specific embodiments of the present invention.

In the figures of the drawings, identical reference numerals designate identical or functionally identical elements, components, or component parts, unless indicated otherwise.

### DETAILED DESCRIPTION OF EXAMPLE EMBODIMENTS

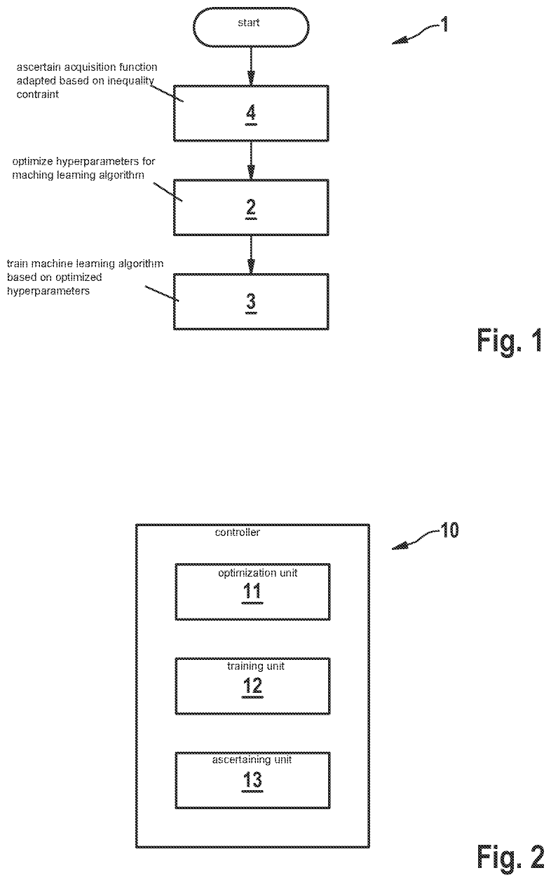

FIG. 1 is a flow chart of a method for training a machine learning algorithm taking into account at least one inequality constraint 1 according to specific embodiments of the present invention.

In this figure, each of the at least one inequality constraint represents a secondary constraint.

Machine learning algorithms are based on two types of parameters, in particular hyperparameters and model parameters or weightings. While the model parameters can, for example, be learned during the training of the machine learning algorithm using labeled training data, the hyperparameters have to be specified before the machine learning algorithm is trained.

In this case, one option for selecting the hyperparameters before training the machine learning algorithm is manually searching for optimal hyperparameters; for example, the most optimal possible hyperparameters are selected on the basis of empirical values and/or various hyperparameters are tested manually. Furthermore, the hyperparameters can also be selected randomly or by a random search, the machine learning algorithm then being trained on the basis of the randomly selected hyperparameters.

Because of the increasing number and complexity of machine learning algorithms, for example, methods for automatically selecting hyperparameters or for automatically optimizing hyperparameters have also been developed. One example of a method of this kind is Bayesian optimization. Bayesian optimization follows earlier evaluation attempts or earlier selections of hyperparameters, on the basis of which a probabilistic model is formed, which maps hyperparameters to a probability of an evaluation of an objective function. In this process, the hyperparameters are selected by optimizing the objective function.

In addition, tree-structured Parzen estimators constitute a development of the Bayesian optimization. In this case, a tree-structured Parzen estimator is understood to be a method which handles categorical hyperparameters in a tree-structured manner, or a method which generates Parzen estimators in a search space comprising conditional hyperparameters. For example, the selection of the number of layers of a neural network and the selection of the number of neurons in the individual layers generate a tree structure. In addition, two distributions are defined for the hyperparameters or densities, in particular one in which output values of an objective function are less than a threshold value and one in which the output values of the objective function are greater than or equal to the threshold value. For example, in this case, the hyperparameters are divided into good values and bad values. In this case, in addition, the objective function is a function which converts hyperparameters into an actual value, and this actual value is to be minimized as part of the hyperparameter optimization. The two densities are then modeled using Parzen estimators or kernel density estimators, which constitute a simple average of kernels that are centered on available data points. In this case, a set of hyperparameters is output according to the greatest expected improvement, or the improvement potential of individual selections of hyperparameters is estimated.

In this case, in comparison with other common methods for optimizing hyperparameters, for example evolution strategies, tree-structured Parzen estimators are characterized by their versatility and stable performance, especially since these are based on distributions.

However, one drawback of tree-structured Parzen estimators has been found to be that, until now, they have not been adapted to models that commonly occur in practice. For instance, in models that commonly occur in practice, boundary conditions or secondary constraints, for example specifications relating to available computing resources, often need to be taken into account. Secondary constraints of this kind are often in the form of inequality constraints.

In this case, FIG. 1 shows a method 1 which comprises a step 2 of optimizing hyperparameters for the machine learning algorithm by applying a tree-structured Parzen estimator, wherein the tree-structured Parzen estimator is based on an acquisition function adapted on the basis of the at least one inequality constraint, and a step 3 of training the machine learning algorithm on the basis of the optimized hyperparameters.

The advantage of the acquisition function being adapted on the basis of the at least one inequality constraint in this case is that the hyperparameters can be optimized effectively even when there is at least one inequality constraint, for example specifications relating to the computing resources available for optimizing the hyperparameters or training the machine learning algorithm, and the optimized hyperparameters are robust in relation to the at least one inequality constraint.

Overall, an improved method for training a machine learning algorithm taking into account secondary constraints 1 in the form of inequality constraints is thus disclosed.

In particular, in this case a method 1 is disclosed which constitutes an expansion of tree-structured Parzen estimators and in which the acquisition function is adapted or expanded on the basis of the at least one inequality constraint.

In this case, the machine learning algorithm can in particular be trained on the hyperparameters which are contained in a configuration for which a value of the acquisition function calculated on the basis of the tree-structured Parzen estimator is at its maximum.

The machine learning algorithm can also be a neural network trained by deep learning, for example. In this case, the hyperparameters to be optimized can be the number of layers of the neural network and the number of neurons per layer, for example.

Furthermore, however, the method is also generally applicable to black box functions, i.e., functions of which only the input-output relationships, and not the internal relationships, are known, or which are defined solely by assignments between input and output values.

As shown in FIG. 1, the method 1 shown further comprises a step 4 of ascertaining the acquisition function adapted on the basis of the at least one inequality constraint, wherein ascertaining the acquisition function adapted on the basis of the at least one inequality constraint includes factorizing each of the at least one inequality constraint.

In particular, in this case, for each of the at least one inequality constraint, an acquisition or selection function for the corresponding inequality constraint can be factorized, i.e., for example, one distribution can be formed for the good values and one distribution can be formed for the bad values.

According to the specific embodiments in FIG. 1, the step 4 of ascertaining the acquisition function adapted on the basis of the at least one inequality constraint further includes multiplying an acquisition function for an objective function by an acquisition function for each of the at least one inequality constraint in each case, the product of the acquisition function for the objective function and the acquisition functions for the individual inequality constraints forming the acquisition function adapted on the basis of the at least one inequality constraint.

The acquisition function adapted on the basis of the at least one inequality constraint can thus be adapted to the setup or specifications of the individual inequality constraints or secondary constraints. Furthermore, the hyperparameters having the same performance as in a commonplace tree-structured Parzen estimator are selected if there are not supposed to be any secondary constraints represented by inequality constraints.

The at least one inequality constraint is further at least one specification relating to available computing resources, for example processor capacities, memory capacities, or latencies.

A machine learning algorithm trained on the basis of accordingly selected or optimized hyperparameters can then be used for classifying image data, for example. In this case, the machine learning algorithm can also have been trained on the basis of labeled comparative image data.

However, on the basis of accordingly labeled comparative image data, the accordingly trained machine learning algorithm can also be trained to control self-driving motor vehicles on the basis of LiDAR and/or radar models, self-driving motor vehicles often having limited resources for optimizing engine controllers or ABS controllers, or to optimize process parameters in the manufacturing of components, for example in resistance welding, injection molding, or metal heat treatment.

FIG. 2 is a schematic block diagram of a controller 10b for training a machine learning algorithm taking into account at least one inequality constraint according to specific embodiments of the present invention.

In this figure, each of the at least one inequality constraint again represents a secondary constraint.

As shown in FIG. 2, the controller 10 comprises an optimization unit 11 configured to optimize hyperparameters for the machine learning algorithm by applying a tree-structured Parzen estimator, wherein the tree-structured Parzen estimator is based on an acquisition function adapted on the basis of the at least one inequality constraint, and comprises a training unit 12 configured to train the machine learning algorithm on the basis of the optimized hyperparameters.

In this case, the optimization unit and the training unit can, for example, each be implemented on the basis of code that is stored in a memory and executable by a processor.

According to the specific embodiments in FIG. 2, the controller further comprises an ascertaining unit 13 configured to ascertain the acquisition function adapted on the basis of the at least one inequality constraint, wherein ascertaining the acquisition function adapted on the basis of the at least one inequality constraint includes factorizing each of the at least one inequality constraint.

In this case, the ascertaining unit can, for example, again be implemented on the basis of code that is stored in a memory and executable by a processor.

According to the specific embodiments in FIG. 2, the ascertaining unit is further configured to ascertain the acquisition function adapted on the basis of the at least one inequality constraint by multiplying an acquisition function for an objective function by an acquisition function of each of the at least one inequality constraint in each case.

The at least one inequality constraint is again also at least one specification relating to available computing resources.

In this case, the controller 10 is in particular configured to perform an above-described method for training a machine learning algorithm taking into account at least one inequality constraint. Furthermore, code implementing the optimization unit, code implementing the training unit, and code implementing the ascertaining unit can also be combined in a computer program product.

What is claimed is:

1. A method for training a machine learning algorithm taking into account at least one inequality constraint, wherein each of the at least one inequality constraint represents a secondary constraint, the method comprising the following steps:
optimizing hyperparameters for the machine learning algorithm by applying a tree-structured Parzen estimator, wherein the tree-structured Parzen estimator is based on an acquisition function adapted based on the at least one inequality constraint; and
training the machine learning algorithm based on the optimized hyperparameters.

2. The method as recited in claim 1, further comprising:
ascertaining the acquisition function adapted based on the at least one inequality constraint, and wherein the ascertaining of the acquisition function adapted based on the at least one inequality constraint includes factorizing each of the at least one inequality constraint.

3. The method as recited in claim 2, wherein the ascertaining of the acquisition function adapted based on the at least one inequality constraint includes multiplying an acquisition function for an objective function by an acquisition function for each of the at least one inequality constraint.

4. The method as recited in claim 1, wherein the at least one inequality constraint is at least one specification relating to available computing resources.

5. A method for classifying image data, comprising:
classifying image data using a machine learning algorithm trained to classify image data, the machine learning algorithm having been trained taking into account at least one inequality constraint, wherein each of the at least one inequality constraint represents a secondary constraint, the training including:
optimizing hyperparameters for the machine learning algorithm by applying a tree-structured Parzen estimator, wherein the tree-structured Parzen estimator is based on an acquisition function adapted based on the at least one inequality constraint; and
training the machine learning algorithm based on the optimized hyperparameters.

6. A controller for training a machine learning algorithm taking into account at least one inequality constraint, wherein each of the at least one inequality constraint represents a secondary constraint, the controller comprising:
an optimization unit configured to optimize hyperparameters for the machine learning algorithm by applying a tree-structured Parzen estimator, wherein the tree-structured Parzen estimator is based on an acquisition function adapted based on the at least one inequality constraint; and
a training unit configured to train the machine learning algorithm based on the optimized hyperparameters.

7. The controller as recited in claim 6, further comprising:
an ascertaining unit configured to ascertain the acquisition function adapted based on the at least one inequality constraint, the ascertaining of the acquisition function adapted based on the at least one inequality constraint includes factorizing each of the at least one inequality constraint.

8. The controller as recited in claim 7, wherein the ascertaining unit is further configured to ascertain the acquisition function adapted based on the at least one inequality constraint by multiplying an acquisition function for an objective function by an acquisition function for each of the at least one inequality constraint.

9. The controller as recited in claim 6, wherein the at least one inequality constraint is at least one specification relating to available computing resources.

10. A controller for classifying image data, the controller being configured to classify image data using a machine learning algorithm trained to classify image data, and wherein the machine learning algorithm has been trained by a controller for training a machine learning algorithm taking into account at least one inequality constraint, the controller for training the machine learning being configured to take into account at least one inequality constraint, wherein each of the at least one inequality constraint represents a secondary constraint, the controller for training the machine learning comprising:
an optimization unit configured to optimize hyperparameters for the machine learning algorithm by applying a tree-structured Parzen estimator, wherein the tree-structured Parzen estimator is based on an acquisition function adapted based on the at least one inequality constraint; and
a training unit configured to train the machine learning algorithm based on the optimized hyperparameters.
